(19) United States
(12) Patent Application Publication
(10) Pub. No.: US 2007/0039479 A1
(43) Pub. Date: Feb. 22, 2007

(54) Beverage brewing devices

(75) Inventors: David Andrew Dalton, Cincinnati, OH (US); Stephen Jerome Westerkamp, Milford, OH (US); Daniel Scott, Berkshire (GB); Arne Benjamin Colman, Notts (GB); Terence Graham Curtis, Bucks (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/505,673

(22) Filed: Aug. 17, 2006

Related U.S. Application Data
(60) Provisional application No. 60/709,091, filed on Aug. 17, 2005.

(51) Int. Cl. A47J 31/44

(52) U.S. Cl. 99/279

(57) ABSTRACT

Beverage brewing devices having a brewing unit having a brewing chamber and a closure mechanism, the closure mechanism having an open and closed orientation and a pod holder configured to hold a pod containing an extractable material, the pod having a peripheral flange, wherein the pod holder has a cup, a ledge extending substantially horizontally from the cup in an outward direction, and a gasket connected to the ledge about the cup, wherein, when the closure mechanism is in the closed orientation, a seal is created between the peripheral flange of the pod and the gasket of the pod holder to prevent bypass of liquid around the pod.

### CROSS REFERENCE TO RELATED APPLICATIONS

This application claims the benefit of priority to U.S. Provisional Application Ser. No. 60/709,091, filed Aug. 17, 2005, which is herein incorporated by reference.

### FIELD OF THE INVENTION

The present invention generally relates to brewing devices, and more particularly, to beverage brewing devices for facilitating disbursement of a brewing liquid through a pre-packaged pod containing extractable material.

### BACKGROUND OF THE INVENTION

In response to consumer demand for faster, more convenient brewers, single-cup brewing devices have recently been introduced. Single-cup brewing devices differ from conventional brewing devices in that single-cup brewing devices can quickly provide one cup of brewed beverage at a time. Additionally, single-cup brewing devices differ from espresso brewers in that single-cup brewing devices may be capable of brewing more than just espresso. Single-cup brewing devices are often designed to work in conjunction with pre-packaged pods, pouches or cartridges containing extractable materials, and in particular, extractable beverage materials, such as coffee, tea, cocoa and the like. In use, the consumer can place a pod into the brewing device and in less than one or two minutes a single-serving of freshly brewed beverage is produced.

One reason single-cup brewing devices are able to rapidly provide a freshly brewed beverage is because the brewing liquid (e.g. water) is forced through the device, and more particularly through the pod, under pressure greater than that of conventional brewers. More specifically, while conventional brewers usually brew at from about 0-1 psi, most single-cup brewing devices can brew at from about 2-25 psi. While the increased pressure can provide a quicker brew cycle than that of conventional brewing devices, it may also result in undesired bypass.

Bypass generally occurs when the water from the brewer travels around the exterior of the pod, rather than passing through the pod. Bypass is undesirable for several reasons. First, bypass may affect the taste of the final beverage because not all of the water intended for extraction of the pod actually passes through the pod. Therefore, the beverage may have a weaker flavor than intended. Second, because the water is passing around (rather than through) the pod, the water may actually leak from the brewing device. Finally, because bypass may result in a lesser degree of extraction than desired, a portion of the extractable material may remain unextracted in the pod, thereby resulting in waste.

Therefore, there remains a need for a brewing device, and more specifically, a single-cup brewing device, having reduced instances of bypass during the brewing cycle.

### SUMMARY OF THE INVENTION

Embodiments of the present invention relate to beverage brewing devices comprising:

a brewing unit having a brewing chamber and a closure mechanism, the closure mechanism having an open and closed orientation;

a pod holder configured to hold a pod containing an extractable material, the pod having a peripheral flange, wherein the pod holder comprises:
a cup;
a ledge extending substantially horizontally from the cup in an outward direction; and
a gasket connected to the ledge about the cup,
   wherein, when the closure mechanism is in the closed orientation, a seal is created between the peripheral flange of the pod and the gasket of the pod holder to prevent bypass of liquid around the pod.

In another aspect, embodiments of the present invention relate to pod holders for use in a brewing device, the pod holder configured to hold a pod containing an extractable material, the pod having a peripheral flange, wherein the pod holder comprises:
a cup;
a ledge extending substantially horizontally from the cup in an outward direction; and
a gasket connected to the ledge about the cup,
   wherein, when the brewing device is in use a seal is created between the peripheral flange of the pod and the gasket of the pod holder to prevent bypass of liquid around the pod.

### BRIEF DESCRIPTION OF THE DRAWINGS

FIG. 1 is a schematic perspective view of one embodiment of a beverage brewing device in accordance with the present invention.

FIG. 2 is a schematic elevated front view of one embodiment of a beverage brewing device in an open orientation containing a brew basket in the brewing chamber in accordance with the present invention.

FIG. 3 is a schematic perspective view of one embodiment of a filter pod in accordance with the present invention.

FIG. 4 is a schematic perspective view of one embodiment of a pod holder having a sealing gasket in accordance with the present invention.

FIG. 5 is a schematic perspective view of one embodiment of a pod holder containing a pod in accordance with the present invention.

FIG. 6 is a schematic cross-sectional view of FIG. 5 along line A-A.

FIG. 6A is an enlarged view of a portion of FIG. 6.

FIG. 7 is a schematic front elevated view of one embodiment of a sealing gasket having a plurality of anchors in accordance with the present invention.

FIG. 8 is a schematic perspective view of one embodiment of a pod holder with the gasket removed, the pod holder having a plurality of slits in accordance with the present invention.

FIG. 9 is a schematic front elevated view of one embodiment of a beverage brewing device containing a pod in accordance with the present invention.

### DETAILED DESCRIPTION OF THE INVENTION

A. Definitions

As used herein, the term “beverage brewing device” means a conventional, multi-cup brewing device or a single-cup brewing device.

As used herein, the term “bypass” means that at least some quantity of the brewing liquid passes around the exterior of the filter pod rather than passing through the filter pod. Thus, the brewing liquid that bypasses the filter pod does not aid in extracting the extractable material contained within the pod.

As used herein, the term “comprising” means various components can be co-jointly employed in the methods and articles of this invention. Accordingly, the terms “consisting essentially of” and “consisting of” are embodied in the term comprising.

As used herein, the term “dynamic condition(s)” means there is additional pressure being exerted other than atmospheric pressure. For example, during a brew cycle, dynamic conditions may exist while the brewing liquid is disbursed under pressure onto and through the pod (e.g. when the flange of the pod is being pressed downward onto the gasket of the pod holder).

As used herein, the term “extractable material” means any solid, liquid, powder or concentrate that may be extracted, dissolved, diluted or suspended to produce a consumable liquid. In one embodiment, the “extractable material” may be an “extractable beverage material,” which includes, but is not limited to, coffee (including, but not limited to, roast and ground, latte, cappuccino and espresso), tea, cocoa, dairy-based materials and/or fruit-based/flavored materials.

As used herein, the term “extracted” or “extract” may not only mean to treat with a solvent so as to remove a soluble substance, but also may include dissolving, diluting or suspending extractable materials as defined herein.

As used herein, the term “liquid extract” means a consumable liquid derived from any solid, liquid, powdered or concentrated extractable material, as defined herein.

As used herein, the term “static condition(s)” means there is generally no additional pressure being exerted other than atmospheric pressure. For example, during a brew cycle, static conditions may exist before the brewing liquid is disbursed under pressure onto and through the pod (e.g. when the flange of the pod is resting on the gasket of the pod holder).

As used herein, the term “substantially liquid tight seal” means that during the dynamic conditions of the brew cycle, less than about 10%, and in one embodiment, less than about 5%, and in another embodiment less than about 1%, of the brewing liquid used during any given brew cycle may bypass the pod during that brew cycle.

B. Beverage Brewing Device

Embodiments of the present invention generally relate to brewing devices for facilitating disbursement of a brewing liquid through a pre-packaged pod containing extractable material.

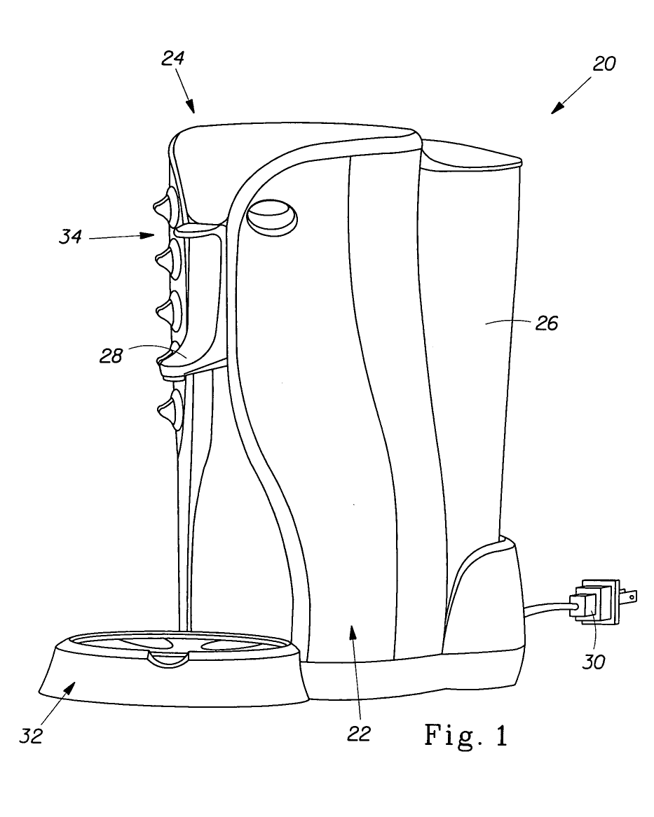

Referring to the drawings wherein like numerals relate to similar features throughout the drawings, FIG. 1 illustrates an exemplary brewing device 20, generally comprising a brewing unit 22 having a closure mechanism 24, a reservoir 26, a spout 28, a power cable 30, an optional drip tray 32 and one or more operation buttons 34. Beverage brewing device 20 may be a conventional, multi-cup brewing device, or, as illustrated in the exemplary drawings, may comprise a single-cup brewing device for brewing extractable materials. While the following description will focus on coffee and coffee beverages, and a single-cup brewing device, it will be understood that such references are for illustration purposes only and the description should not be limited to such beverages or devices.

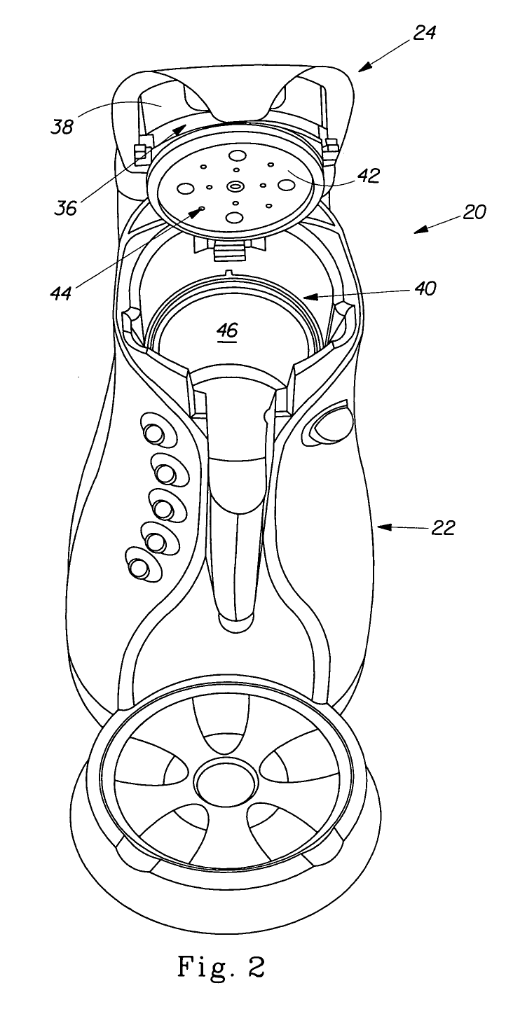

Referring generally to FIGS. 2-6, FIG. 2 shows brewing device 20 with the closure mechanism 24 in an open orientation. As discussed further below, in actual use, a lid 36, and a cover 38 of closure mechanism 24 may be rotatably associated with brewing unit 22. With closure mechanism 24 in an upright and open orientation, a consumer may access a brewing chamber 40 within brewing unit 22. This allows the consumer to insert a supply of extractable material into brewing chamber 40 to carry out a brewing operation, and then remove the extracted material from brewing chamber 40 once the brewing operation has been completed. In one embodiment, the extractable material may be any solid, liquid, powder or concentrate that may be extracted, dissolved, diluted or suspended to produce a consumable liquid. In one embodiment, the extractable material may be an extractable beverage material, which includes, but is not limited to, coffee (including, but not limited to, roast and ground, latte, cappuccino and espresso), tea, cocoa, dairy-based materials and/or fruit-based/flavored materials. The extractable material may be contained within a filter pod, cartridge or the like as described herein below.

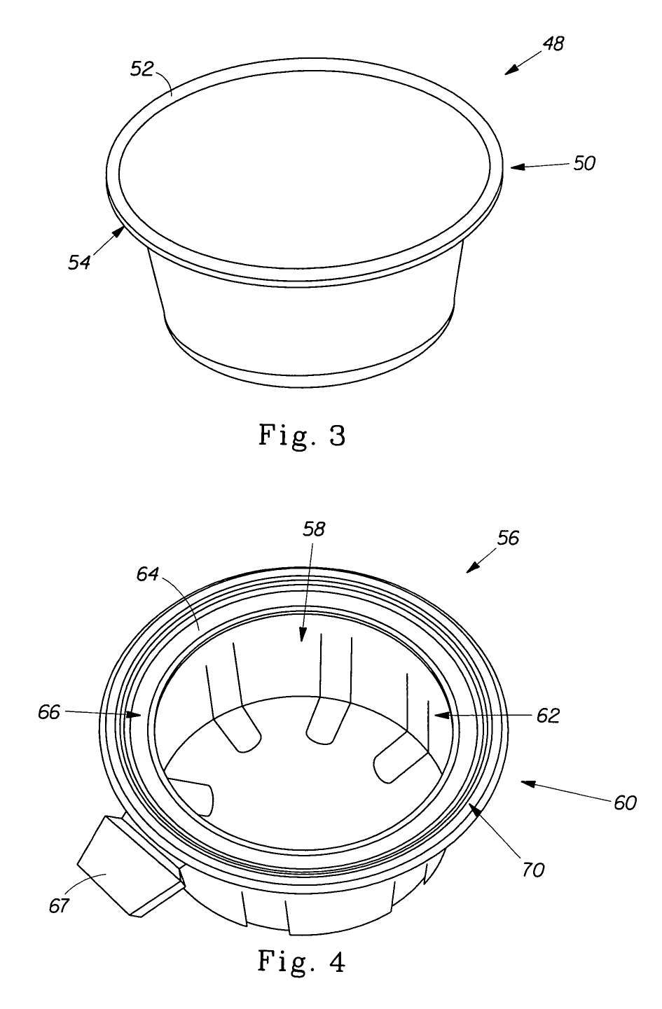

Closure mechanism 24 may further comprise a distributor plate 42 operably associated with the underside of closure mechanism 24 above brewing chamber 40 to disperse the brewing liquid into the brewing chamber 24. Distributor plate 42 may comprise one or more openings 44 for dispensing a brewing liquid under pressure onto, for instance, a pod 48 of extractable material (shown in FIG. 3) that may be contained within brewing chamber 40. Distributor plate 42 may be operably associated with closure mechanism 24 by, for example, a threaded screw connection, a bayonet connection, an interference fit, or any other suitable connection.

Brewing chamber 40 may comprise a brew basket 46, which may be removably associated with brewing unit 22 to facilitate placement and removal of pod 48 and also allow easy maintenance and cleaning. Typically the extractable brewing material is disposed within brew basket 46 of brewing chamber 40. As shown in FIG. 3 and as previously described, the brewing material may be contained within filter pod 48. Pod 48 may help contain the extractable material within brewing chamber 40 throughout the brewing process, while permitting a liquid extract to pass from the inside to the outside of pod 48 and ultimately, out of brewing device 20 into the consumer's cup. Filter pod 48 may be constructed of any suitable material known in the art, such as, for example, spun-bonded or melt-blown non-woven polypropylene, spun-bonded or melt-blown polyester, spun-bonded nylon web, spun-bonded or melt-blown high density polyethylene and combinations thereof. As illustrated, filter pod 48 may comprise a peripheral flange 50 having a top surface 52 and a bottom surface 54. Flange 50 may be made from any suitable material known in the art, including, but not limited to, plastic, filter material, paper, metal or the like. In one embodiment, flange 50 may be substantially rigid and may be constructed from, for example, plastic or metal.

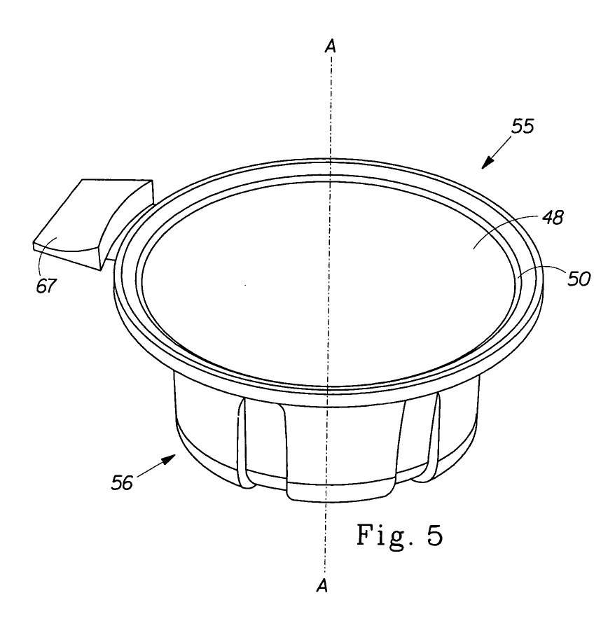

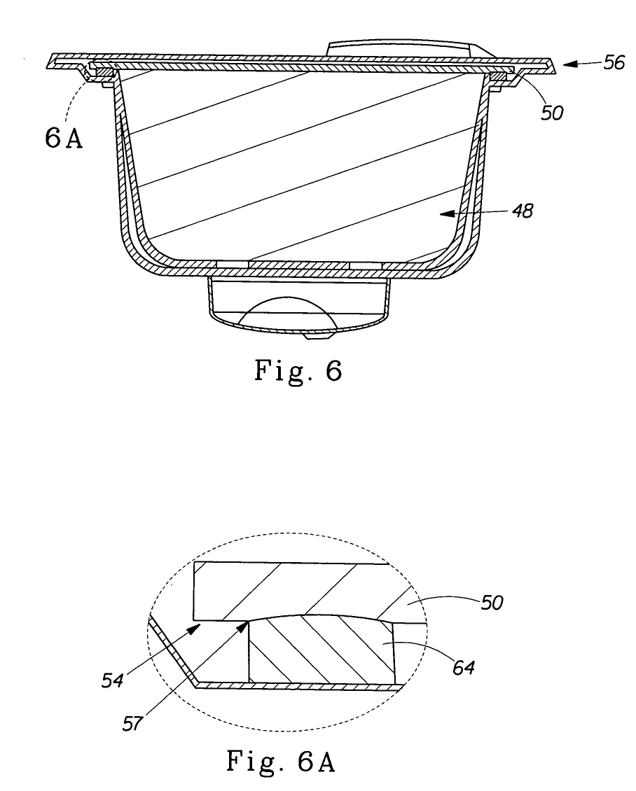

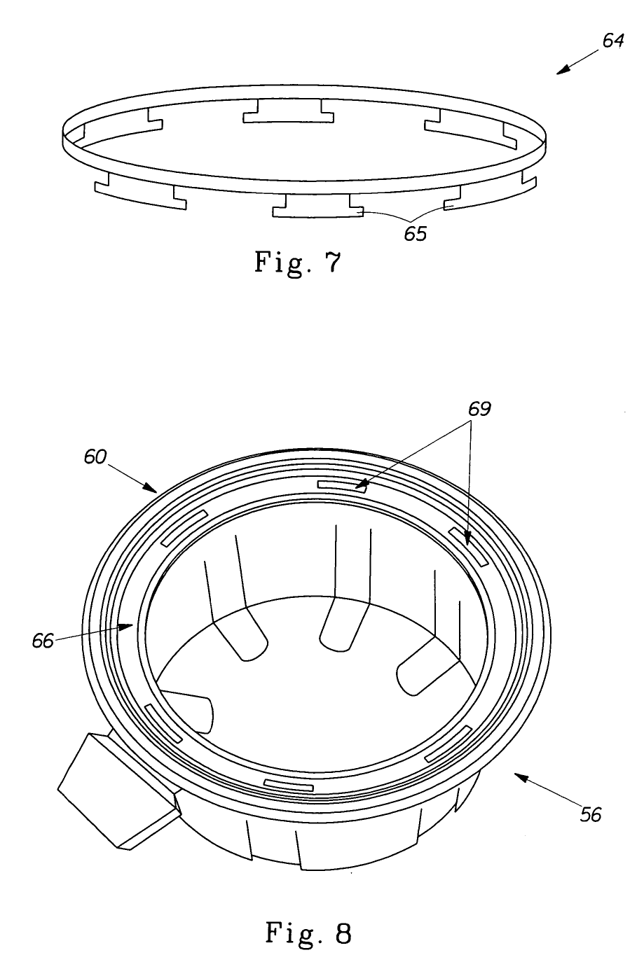

Referring generally to FIGS. 2-6, pod 48 (FIG. 3) may be contained within a pod holder 56 (FIG. 4) thereby creating a pod assembly 55 (FIGS. 5-6). Pod holder 56 may be receivable by brew basket 46. Pod holder 56 may not only help ensure proper placement of pod 48 into brewing chamber 40, but also may help create a substantially liquid tight seal to reduce or prevent bypass of a brewing liquid about pod 48, as described herein below. Additionally, pod holder 52 may optionally comprise a handle 67 for easier handling. Pod holder 56 may comprise a cup 58 for receiving pod 48, as well as a ledge 60 extending substantially horizontally from an open top 62 of cup 58 in an outward direction. Pod holder 56 may generally be constructed from any suitable material known in the art, such as for example, metals or plastics. A sealing gasket 64 may be situated on top of at least a portion of an inwardly disposed portion 66 of ledge 60 such that sealing gasket 64 may be disposed about cup 58, and more specifically, about open top 62 of cup 58, of pod holder 56. It will be understood by those skilled in the art that sealing gasket 64 may be disposed around open top 62 of cup 58, such that gasket 64 may be either flush with cup 58 or at a distance away from cup 58 (as illustrated in FIG. 4). Sealing gasket 64 may be made from silicone rubber or other like material and may help prevent the brewing liquid from bypassing (e.g. flowing around) pod 48 as described herein below. Sealing gasket 64 may be operably connected to pod holder 56 in a variety of ways. For example, in one embodiment, sealing gasket 64 may comprise a plurality of anchors 65 that may be received by a plurality of complementary slits 69 in pod holder 56, and more specifically, in inwardly disposed portion 66 of ledge 60 of pod holder 56. (Shown in FIGS. 7 and 8 respectively). Those skilled in the art will understand that other arrangements for connecting gasket 64 to pod holder 56 are also acceptable.

As shown in FIGS. 5 and 6, when pod 48 is placed within pod holder 56, bottom surface 54 of peripheral flange 50 of pod 48 may rest upon sealing gasket 64 of pod holder 56 to create a substantially liquid tight seal 57 during both static and dynamic conditions. Flange 50 may be designed such that at least about 5% of flange 50 rests on gasket 64, and in one embodiment at least about 25%, and in another embodiment at least about 50%, and in yet another embodiment at least about 75% and in still another embodiment at least about 100%, of flange 50 rests on gasket 64. Additionally, under static conditions (e.g. when flange 50 is resting on gasket 64 at atmospheric pressure), seal 57 created by peripheral flange 50 and sealing gasket 64 may help reduce, or even eliminate, the brewing liquid from bypassing pod 48 at pressures of up to about 5 psi, and in one embodiment from about 0.1 psi to about 5 psi. During dynamic conditions (e.g. when flange 50 is pressed downward onto gasket 64 by greater than atmospheric pressure) of the brew cycle, such as when brewing liquid passes through the brewing unit, and more specifically, through pod 48, the previously mentioned seal 57 between flange 50 and sealing gasket 64 is reinforced such that seal 57 may help to substantially prevent the brewing liquid from bypassing pod 48 at pressures of greater than about 0.1 psi, and in one embodiment from about 1 psi to about 40 psi, and in another embodiment from about 1 psi to about 25 psi, and in yet another embodiment from about 1 psi to about 20 psi and in still another embodiment from about 1 psi to about 15 psi. This seal 57 between flange 50 and sealing gasket 64 is further described herein below.

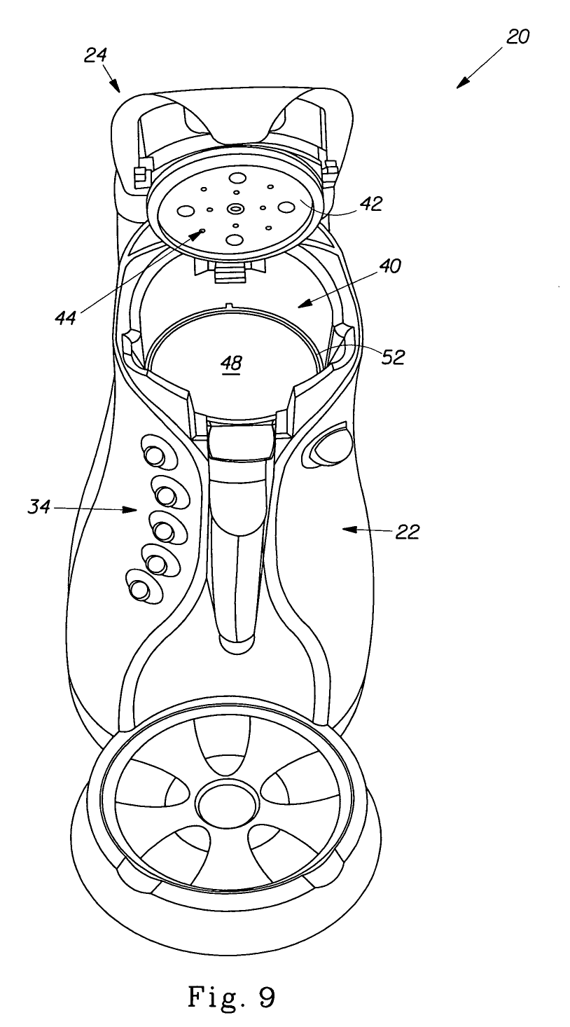

Referring to FIGS. 6 and 9, in use, with closure mechanism 24 in an upright and open position, the consumer may place pod 48 into pod holder 52 and place pod holder 52 into brewing chamber 40, as shown in FIG. 9, and close the closure mechanism 24. Next, the power cable may be plugged into an electricity source to supply electricity to the brewing device. The consumer may then initiate a brewing cycle by pushing the desired operation buttons 34, thereby prompting an electronic control module (not shown) in brewing unit 22 to operate a pump (not shown) in brewing unit 22 to remove a supply of brewing liquid from the reservoir. The brewing liquid may then be heated by a heater (not shown) within brewing unit 22. The pump then moves the heated brewing liquid under pressure through a flexible tube (not shown), which liquidly connects the reservoir to the interior of brewing unit 22 and further on to closure mechanism 24 where the brewing liquid may be dispensed onto pod 48 via the at least one opening 44 of distributor plate 42.

As the hot, pressurized brewing liquid is dispensed onto pod 48, pod 48 is pressed downward onto gasket 64 of pod holder 56, both by the force of the pressurized brewing liquid being dispensed onto pod 48 and by the increased weight of pod 48 as the brewing liquid collects inside pod 48 to dissolve the extractable material contained therein. More specifically, bottom surface 54 of flange 50 is pressed downward onto sealing gasket 64 of pod holder 56, thereby reinforcing the substantially liquid tight seal 57 previously described for preventing the brewing liquid from bypassing pod 48. As a result, the pressurized brewing liquid dispensed onto pod 48 from distributor plate 42 can be directed through pod 48, rather than around pod 48, thus helping to ensure proper extraction of the extractable material within pod 48. Once extracted, the resulting brewed beverage may pass through pod 48 and out of the brewing chamber 40 through one or more openings disposed in or near the bottom of the brew basket 46. Fluid passageways in the brewing unit 22 lead the brewed beverage to the spout from which the brewed beverage may be dispensed into the consumer's cup. Once the brewing operation is completed, the user may open closure mechanism 24 again to gain access to brewing chamber 40 and remove the used brewing material and filter material for disposal. Brewing device 20 is then ready for another brewing operation.

It will be understood that embodiments of the brewing devices described herein may comprise additional components common to many conventional brewing devices but not shown in the present illustrations. Furthermore, embodiments of brewing device, as well as components thereof described herein, may be constructed of a variety of materials, including, but not limited to, plastic, metals and the like. Those skilled in the art will understand how to select the optimum material for constructing the various components based on each component's function.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A beverage brewing device comprising:
a brewing unit having a brewing chamber and a closure mechanism, the closure mechanism having an open and closed orientation; and
a pod holder configured to hold a pod containing an extractable material, the pod having a peripheral flange, wherein the pod holder comprises:
a cup;
a ledge extending substantially horizontally from the cup in an outward direction; and
a gasket connected to the ledge about the cup,
wherein, when the closure mechanism is in the closed orientation, a seal is created between the peripheral flange of the pod and the gasket of the pod holder to substantially prevent bypass of liquid around the pod.

2. The beverage brewing device of claim 1 wherein, in use, the seal substantially prevents bypass of liquid around the pod at pressures of greater than about 0.1 psi.

3. The beverage brewing device of claim 1 wherein the gasket comprises a plurality of anchors receivable by a plurality of complementary slits in the pod holder to connect the gasket to the pod holder.

4. The beverage brewing device of claim 1 wherein the peripheral flange of the pod is substantially rigid.

5. The beverage brewing device of claim 1 wherein, in use, the seal substantially prevents bypass of liquid around the pod at pressures of from about 1 psi to about 40 psi.

6. A pod holder for use in a brewing device, the pod holder configured to hold a pod containing an extractable material, the pod having a peripheral flange, wherein the pod holder comprises:
a cup;
a ledge extending substantially horizontally from the cup in an outward direction; and
a gasket connected to the ledge about the cup,
wherein, when the brewing device is in use a seal is created between the peripheral flange of the pod and the gasket of the pod holder to substantially prevent bypass of liquid around the pod.

7. The beverage brewing device of claim 6 wherein, in use, the seal substantially prevents bypass of liquid around the pod at pressures of greater than about 0.1 psi.

8. The beverage brewing device of claim 6 wherein the gasket comprises a plurality of anchors receivable by a plurality of complementary slits in the pod holder to connect the gasket to the pod holder.

9. The beverage brewing device of claim 6 wherein the peripheral flange of the pod is substantially rigid.

10. The beverage brewing device of claim 6 wherein, in use, the seal substantially prevents bypass of liquid around the pod at pressures of from about 1 psi to about 40 psi.
